(19) United States
(12) Patent Application Publication
(10) Pub. No.: US 2025/0192211 A1
(43) Pub. Date: Jun. 12, 2025

(54) FUEL CELL SYSTEM AND FUEL CELL SYSTEM CONTROL METHOD

(71) Applicants: Hyundai Motor Company, Seoul (KR); Kia Corporation, Seoul (KR)

(72) Inventors: Seung Ho Shin, Yongin-si (KR); Byeong Eun Cho, Incheon (KR)

(21) Appl. No.: 18/802,599

(22) Filed: Aug. 13, 2024

(30) Foreign Application Priority Data
Dec. 6, 2023 (KR) 10-2023-0175952

(51) Int. Cl. H01M 8/04828; H01M 8/0432; H01M 8/04492; H01M 8/04537; H01M 8/04746

(52) U.S. Cl. CPC H01M 8/04828; H01M 8/04358; H01M 8/04492; H01M 8/04544; H01M 8/04753

(57) ABSTRACT

An embodiment fuel cell system includes a fuel cell stack, including a cathode and an anode, and a controller configured to determine a drying state or a flooding state of the fuel cell stack based on a temperature difference between a coolant inlet and a coolant outlet, determine a state of the cathode or the anode based on a temperature change of a cathode outlet or an anode outlet, and pressurize the cathode or the anode based on the state of the cathode or the anode.

### CROSS-REFERENCE TO RELATED APPLICATIONS

This application claims the benefit of Korean Patent Application No. 10-2023-0175952, filed on Dec. 6, 2023, which application is hereby incorporated herein by reference.

### TECHNICAL FIELD

The disclosure relates to a fuel cell system and fuel cell system control method.

### BACKGROUND

A fuel cell is a device that receives hydrogen and air from the outside and generates electrical energy through an electrochemical reaction inside a fuel cell stack. The fuel cell can be used as a power source in various fields such as a fuel cell electric vehicle (FCEV) and a fuel cell for power generation.

A fuel cell system includes a fuel cell stack that stacks multiple fuel cells used as a power source, a hydrogen supply system that supplies hydrogen as fuel to the fuel cell stack, an air supply system that supplies oxygen, an oxidizing agent necessary for electrochemical reactions, and a cooling system that controls the temperature of the fuel cell stack.

During operation of the fuel cell stack, water is produced through the reaction of hydrogen and oxygen. Such produced water accumulates in the cells that constitute the fuel cell stack in the short term, causing performance differences between cells, and deteriorates the catalyst of the fuel cell stack in the long term.

On the other hand, when operating the fuel cell stack, the humidity of the fuel cell stack is low, so performance differences between cells may occur even in dry conditions, and this may cause catalyst deterioration.

In this way, in order for the fuel cell stack to operate in an optimal state, the inside of the fuel cell stack needs to be maintained at optimal humidity.

The information disclosed in this background section is only for enhancement of understanding of the general background of the disclosure and should not be taken as an acknowledgement that this information forms the already known prior art.

### SUMMARY

Embodiments of the disclosure provide a fuel cell system that determines the state of a fuel cell stack by analyzing the state of generated water in the fuel cell stack and optimizes the operation of the fuel cell stack through the determination, thereby reducing the performance deviation of the cells of the fuel cell in the short term and suppressing catalyst deterioration of the fuel cell stack in the long term.

A fuel cell system according to embodiments of the disclosure comprises a fuel cell stack including a cathode and anode and a controller that determines a drying or flooding state of the fuel cell stack based on a temperature difference between a coolant inlet and a coolant outlet, determines a state of one or more of the cathode and the anode based on a temperature change of one or more of a cathode outlet and an anode outlet, and pressurizes one or more of the cathode and the anode based on the determined state of the cathode or the anode.

If a cell voltage deviation (RV) of the fuel cell stack is less than a reference deviation, the controller determines the drying or flooding state of the fuel cell stack based on the temperature difference between the coolant inlet and the coolant outlet.

The controller calculates a higher heating value (HHV) and a lower heating value (LHV) of the fuel cell stack based on one or more of an output voltage or an output current of the fuel cell stack, sets a reference range based on the calculated higher heating value (HHV) and the calculated lower heating value (LHV), and may determine the drying or flooding state of the fuel cell stack by comparing the temperature difference between the coolant inlet and the coolant outlet and the reference range.

If the temperature difference between the coolant inlet and the coolant outlet is outside the reference range, the controller may determine that the fuel cell stack is currently in the drying or flooding state.

If the fuel cell stack is determined to be in the flooding state, the controller may increase an operating temperature of the fuel cell stack, and if the fuel cell stack is determined to be in the drying state, the controller may reduce the operating temperature of the fuel cell stack.

If the fuel cell stack is determined to be in the flooding state and a temperature increase at the cathode outlet is determined to be greater than that at the anode outlet, the controller may determine that flooding has occurred at the cathode and pressurize the cathode.

If the fuel cell stack is determined to be in the flooding state and a temperature increase at the anode outlet is determined to be greater than that at the cathode outlet, the controller may determine that flooding has occurred at the anode and pressurize the anode.

If the fuel cell stack is determined to be in the drying state and a temperature decrease at the cathode outlet is determined to be greater than that at the anode outlet, the controller may determine that the cathode is dry and pressurize the anode.

If the fuel cell stack is determined to be in the drying state and a temperature decrease at the anode outlet is determined to be greater than that at the cathode outlet, the controller may determine that the anode is dry and pressurize the cathode.

The controller stores an output current section of the fuel cell stack where a cell voltage deviation is measured to be less than a reference deviation, and if a current output current of the fuel cell stack is included in the stored output current section of the fuel cell stack, the controller may determine the state of one or more of the cathode and the anode based on the temperature change of one or more of the cathode outlet and the anode outlet.

The controller may pressurize one or more of the cathode and the anode according to a result of determining the state of one or more of the cathode and the anode.

After pressurizing one or more of the cathode and the anode, the controller may monitor whether the cell voltage deviation is greater than or equal to the reference deviation within the stored output current section of the fuel cell stack.

A control method of a fuel cell system according to embodiments of the disclosure comprises the steps of determining, by a controller, a drying or flooding state of a fuel cell stack based on a temperature difference between a coolant inlet and a coolant outlet, determining, by the controller, a state of one or more of a cathode and an anode based on a temperature change of one or more of a cathode outlet and an anode outlet, and pressurizing one or more of the cathode and the anode based on the state of the cathode or the anode determined by the controller.

In the step of determining the drying or flooding state of the fuel cell stack, if the cell voltage deviation (RV) of the fuel cell stack is less than a reference deviation, the drying or flooding state of the fuel cell stack is determined based on the temperature difference between the coolant inlet and the coolant outlet.

In the step of determining the drying or flooding state of the fuel cell stack, the controller calculates a higher heating value (HHV) and a lower heating value (LHV) of the fuel cell stack based on one or more of an output voltage or an output current of the fuel cell stack, sets a reference range based on the calculated higher heating value (HHV) and the calculated lower heating value (LHV), and may determine the drying or flooding state of the fuel cell stack by comparing the temperature difference between the coolant inlet and the coolant outlet and the reference range.

According to the fuel cell system and fuel cell system control method of embodiments of the disclosure, the performance deviation of the cells of the fuel cell can be reduced in the short term, and catalyst deterioration of the fuel cell stack can be suppressed in the long term.

### BRIEF DESCRIPTION OF THE DRAWINGS

FIG. 1 is a configuration diagram of a fuel cell system according to embodiments of the disclosure.

FIG. 2 is a graph for explaining a fuel cell system according to embodiments of the disclosure.

FIG. 3 is a flowchart of a fuel cell system control method according to an embodiment of the disclosure.

### DETAILED DESCRIPTION OF ILLUSTRATIVE EMBODIMENTS

Hereinafter, embodiments of the disclosure will be described in detail with reference to the attached drawings. The same or similar components are given the same reference numbers and redundant description thereof is omitted.

Further, in the following description, if a detailed description of known techniques associated with the disclosure would unnecessarily obscure the gist of the disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but they do not preclude the presence or addition of one or more other features, integers, steps, operations, elements, components, and/or combinations.

A controller may include a communication device for communicating with other controllers or sensors to control functions that the controller is in charge of, a memory for storing an operating system or logic commands and input/output information, and one or more processors executing judgment, calculation, determination, and the like necessary for controlling the functions the controller is in charge of.

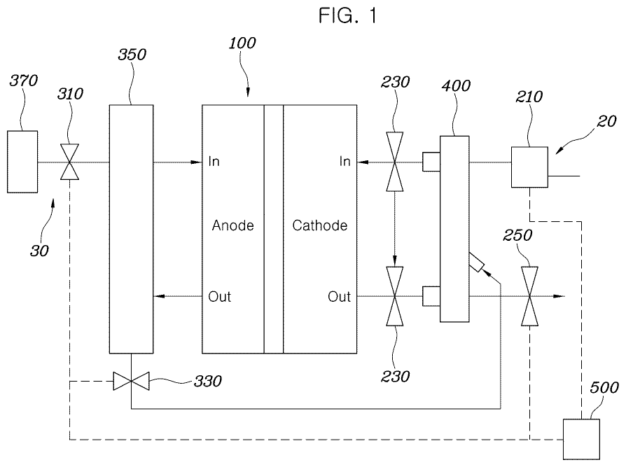

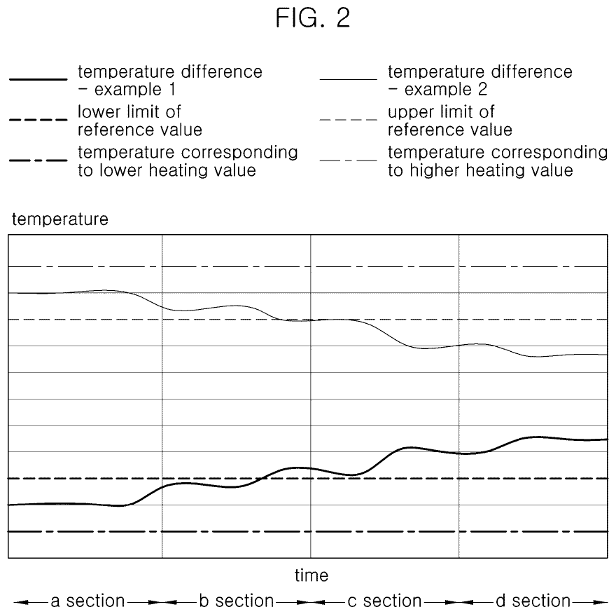

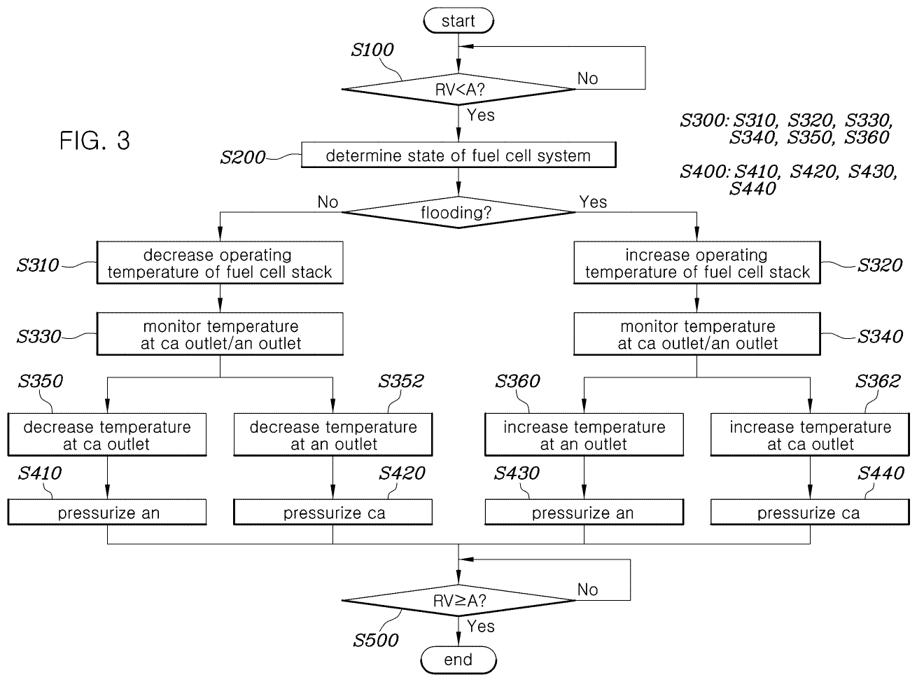

FIG. 1 is a configuration diagram of a fuel cell system according to embodiments of the disclosure, FIG. 2 is a graph for explaining a fuel cell system according to embodiments of the disclosure, and FIG. 3 is a flowchart of a fuel cell system control method according to an embodiment of the disclosure.

The fuel cell system may be provided with an air supply system 20 to supply air to a cathode of a fuel cell stack 100 and a hydrogen supply system 30 to supply hydrogen to an anode of the fuel cell stack 100.

Specifically, the air supply system 20 may include one or more of an air compressor 210, a humidifier 400, an air flow control valve 230, and an air pressure control valve 250, and the hydrogen supply system 30 may include one or more of a hydrogen tank 370, a hydrogen supply valve 310, an ejector 350, and a hydrogen purge valve 330.

A controller 500 determines the drying or flooding state of the fuel cell stack 100 based on a temperature difference between a coolant inlet and a coolant outlet (S200), determines the state of one or more of the cathode and the anode based on a temperature change of one or more of a cathode outlet and an anode outlet (S300), and pressurizes one or more of the cathode and the anode based on the determined state of the cathode or the anode (S400), thereby optimizing the operating humidity of the fuel cell stack.

Specifically, when hydrogen and oxygen react in the fuel cell stack 100, water is generated and heat is generated. The fuel cell system may include a cooling system to cool the heat generated by the fuel cell stack 100. The cooling system cools the fuel cell stack 100 by flowing coolant into the coolant inlet of the fuel cell stack 100, and the coolant that has cooled the fuel cell stack 100 flows out to the coolant outlet of the fuel cell stack 100, cools the fuel cell stack 100 again, and then flows into the fuel cell stack 100 through the coolant inlet.

A coolant temperature sensor may be provided at the coolant inlet and the coolant outlet to measure the temperature of the coolant flowing into the fuel cell stack 100 and the temperature of the coolant flowing out of the fuel cell stack 100, and the coolant temperature sensor may transmit the measured temperature data to the controller 500.

The controller 500 may determine the drying or flooding state of the fuel cell stack 100 based on the temperature difference between the coolant inlet and the coolant outlet (S200). This is because the higher the temperature difference between the coolant inlet and the coolant outlet, the higher the probability that the generated water exists in a liquid state, and the lower the temperature difference between the coolant inlet and the coolant outlet, the higher the probability that the generated water exists in a gaseous state.

Based on the temperature difference between the coolant inlet and the coolant outlet, if there is a high probability that the generated water exists as a liquid, the state of the fuel cell stack 100 may be close to a flooding state, and if there is a high probability that the generated water exists as a gas, the state of the fuel cell stack 100 may be close to a drying state.

When the drying or flooding state of the fuel cell stack 100 is determined, the controller 500 monitors the temperature change of one or more of the cathode outlet and the anode outlet (S330, S340). The fuel cell system may be provided with a cathode temperature sensor or an anode temperature sensor to measure the temperature of one or more of the cathode outlet and the anode outlet. The cathode temperature sensor or the anode temperature sensor may transmit the measured temperature data to the controller 500.

The controller 500 may determine which of the cathode outlet and the anode outlet has a greater tendency to increase or decrease temperature (S350, S360) and determine that drying or flooding has occurred where the temperature change is greater.

In other words, if the temperature increase at the cathode outlet is greater than the temperature increase at the anode outlet, it can be determined that flooding occurs mainly at the cathode, and if the temperature increase at the anode outlet is greater than the temperature increase at the cathode outlet, it can be determined that flooding mainly occurs at the anode.

On the other hand, if the temperature decrease at the cathode outlet is greater than the temperature decrease at the anode outlet, it can be determined that drying occurs mainly at the cathode. If the temperature decrease at the anode outlet is greater than the temperature decrease at the cathode outlet, it can be determined that drying occurs mainly at the anode.

If it is determined that dryness or flooding occurs in the cathode or the anode, the controller 500 may pressurize the cathode or the anode (S400). Here, pressurization means that in case of pressurizing the cathode, the air compressor 210 is driven to introduce air into the cathode, and in case of pressurizing the anode, the high-pressure hydrogen stored in the hydrogen tank 370 is supplied to the anode through the opening of the hydrogen supply valve 310. The pressurization has a relative meaning and should be interpreted as hydrogen can be supplied to the anode even when the cathode is pressurized, and air can be supplied to the cathode even when the anode is pressurized.

Meanwhile, the controller 500 appropriately relieves the drying or flooding state of the cathode or the anode through the above-described determination process to reduce the performance deviation of the cells of the fuel cell in the short term and suppress the catalyst deterioration of the fuel cell stack 100 in the long term.

Meanwhile, the controller 500 may determine the drying or flooding state of the fuel cell stack 100 when the cell voltage deviation (RV) of the fuel cell stack 100 is less than a reference deviation (S200). Cell voltage deviation (RV) refers to the minimum cell voltage among the plurality of cells constituting the fuel cell stack divided by the average cell voltage.

That is, when it is determined by the controller 500 that the cell voltage deviation of the fuel cell stack 100 has decreased below a reference value and the performance deviation between cells has worsened or is expected to be worsen, the controller 500 may determine the state of the fuel cell stack to reduce the performance deviation between cells (S200).

To perform this, the controller 500 may continuously monitor the cell voltage deviation of the fuel cell stack 100 and monitor whether the cell voltage deviation of the fuel cell stack 100 is less than a reference deviation (S100).

Meanwhile, the drying or flooding state of the fuel cell stack 100 can be determined based on the temperature difference between the coolant inlet and the coolant outlet. Specifically, the controller 500 may determine the drying or flooding state of the fuel cell stack 100 (S200) by comparing the temperature difference between the coolant inlet and the coolant outlet with a reference range that is set based on the higher heating value (HHV) and the lower heating value (LHV) of the fuel cell stack 100 and determining that the temperature difference is within or outside the reference range.

The controller 500 may calculate the higher heating value (HHV) and the lower heating value (LHV) of the fuel cell stack 100 based on one or more of the output voltage and the output current of the fuel cell stack 100. Here, the higher heating value refers to a heating value when the generated water occurs in a liquid state, and the lower heating value refers to a heating value when the generated water occurs in a gaseous state. When the generated water is generated in a gaseous state, it absorbs some of the heat generation of the fuel cell stack and exists in a gaseous state, so the higher heating value has a higher value than the lower heating value.

As an example, the heating value can be calculated by multiplying a current density, a total reaction area, and an irreversible potential. Here, the current density refers to the currently measured current density, and the total reaction area is calculated by multiplying the reaction area per cell by the total number of cells. The irreversible potential is a value obtained by subtracting a reversible potential from a reference state potential, and the irreversible potential corresponding to the higher heating value and the irreversible potential corresponding to the lower heating value are respectively used. To do this, the reference state potential and the reversible potential to obtain the higher heating value and the reference state potential and the reversible potential to obtain the lower heating value are prepared in advance as a table for each temperature section, stored in memory, and used in a calculation formula when necessary. Through this process, the higher heating value and the lower heating value are obtained respectively.

Table 1 below is an example of data showing the reference state potential and the reversible potential at 60° C.

TABLE 1

| | Enthalpy of | Entropy | Gibbs free | | |
|---|---|---|---|---|---|
| | formation, | change, | energy, | | |
| | ΔH | ΔS | ΔG | Eₘₐₓ | Eᵣₑᵥ |
| Lower | −242304.16 | −45.6215 | −227112.21 | 1.2557 V | 1.1769 V |
| Heating | J/mol | J/mol K | J/mol | | |
| Value | | | | | |
| Higher | −286313.16 | −169.036 | −230024.14 | 1.4837 V | 1.1920 V |
| Heating | J/mol | J/mol K | J/mol | | |
| Value | | | | | |

In the example above, the reference state potential is Eₘₐₓ and the reversible potential is Eᵣₑᵥ.

Further, if the current density is measured as 1.8633, the reaction area per cell is 204, the total number of cells is 440, and the temperature of the fuel cell stack is assumed to be 60 degrees, the higher heating value and the lower heating value are derived as follows.

$$\begin{matrix}{Q}_{gen , rev} = i A [ {E}_{max} - {E}_{rev} ] = 1.8633 A / {cm}^{2} \times 204 {cm}^{2} [ {E}_{max} - {E}_{rev} ] \times 440 cell \\ {Q}_{gen , rev} = 13167.4 W ( LHV ) \\ {Q}_{gen , rev} = 48787.6 W ( HHV )\end{matrix}$$

After deriving the higher heating value and the lower heating value in the same manner as above and using the derived higher heating value and the derived lower heating value, a reference range is set. The reference range is a reference range for a temperature difference between the coolant inlet and the coolant outlet. The temperature value can be inverted by the heating value, the specific heat of water, and the amount of generated water, and through this, a reference for the temperature difference between the coolant inlet and the coolant outlet is prepared. However, a value obtained by multiplying the temperature derived through the higher heating value by the coefficient of 0.8 may be used as an upper limit of the reference range, and a value obtained by multiplying the temperature derived through the lower heating value by the coefficient of 1.2 may be used as a lower limit of the reference range. This reference range or the upper and lower limits of the reference range are set to a range that can suppress irreversible damage to the cells of the fuel cell after a target operating time, and the corresponding value may be determined through durability tests, etc.

FIG. 2 is a graph for explaining a fuel cell system according to embodiments of the disclosure.

The controller 500 may determine the drying or flooding state of the fuel cell stack by comparing the temperature difference between the coolant inlet and the coolant outlet and the reference range set as described above (S200). In particular, if the temperature difference between the coolant inlet and the coolant outlet is less than the lower limit of the reference range, it can be determined that the fuel cell stack 100 is in a drying state, and if the temperature difference between the coolant inlet and the coolant outlet is greater than the upper limit of the reference range, it can be determined that the fuel cell stack 100 is in a flooding state.

### Example 1

In Example 1, a temperature difference between a coolant inlet and a coolant outlet in section a is below a reference range, and a fuel cell stack is in a drying state. In this case, as will be described later, a controller may relieve the drying state of the fuel cell stack by pressurizing one or more of a cathode and an anode. In section b, the fuel cell stack is also in a drying state, but the drying state is relieved compared to that in section a. In the second half of section b, the temperature difference at the coolant outlet is within the reference range, confirming that the drying state of the fuel cell stack is relieved.

### Example 2

In Example 2, in section a, the temperature difference between the coolant inlet and the coolant outlet exceeds the reference range, and the fuel cell stack is in a flooding state. In this case, as will be described later, the controller may relieve the flooding state of the fuel cell stack by pressurizing one or more of the cathode and the anode. In section b, the fuel cell stack is also in a flooding state, but the flooding state is relieved compared to that in section a. In the second half of section b, the temperature difference at the coolant outlet is within the reference range, confirming that the flooding state of the fuel cell stack is relieved.

If the temperature difference between the coolant inlet and the coolant outlet is above the lower limit of the reference range or below the upper limit of the reference range, it can be determined that the fuel cell stack is in a normal state, and operation of the fuel cell stack can be continued under normal conditions.

Meanwhile, when the temperature difference between the coolant inlet and the coolant outlet is greater than the upper limit of the reference range and it is determined that the fuel cell stack is in a flooding state, the controller 500 may increase the operating temperature of the fuel cell stack 100 (S320).

On the other hand, when the temperature difference between the coolant inlet and the coolant outlet is less than the lower limit of the reference range and it is determined that the fuel cell stack is in a drying state, the controller 500 may reduce the operating temperature of the fuel cell stack 100 (S310).

That is, when it is determined that the fuel cell stack 100 is in a flooding state, the performance deviation of the cells of the fuel cell may be temporarily reduced by first increasing the operating temperature of the fuel cell stack and lowering the relative humidity. On the other hand, when it is determined that the fuel cell stack is in a drying state, the performance deviation of the cells of the fuel cell may be temporarily reduced by first lowering the operating temperature of the fuel cell stack 100 and increasing the relative humidity.

Meanwhile, secondarily, in order to recover fundamental performance deviations of the cells of the fuel cell, the controller 500 may determine the state of the cathode or the anode and pressurize the cathode or the anode (S400).

Specifically, the controller 500 may determine whether flooding or drying mainly occurs at the cathode or the anode by identifying the temperature change tendency of the cathode outlet and the anode outlet.

That is, if it is determined that the fuel cell stack 100 is in a flooding state because the temperature difference between the coolant inlet and the coolant outlet is greater than the upper limit of the reference range, and in a case where it is determined that the temperature increase at the cathode outlet is greater than the temperature increase at the anode outlet (S362), the controller 500 may determine that flooding has occurred at the cathode and pressurize the cathode (S440).

If it is determined that flooding occurs mainly at the cathode, the controller 500 gradually pressurizes the cathode by driving the air compressor 210 to push the generated water generated in the cathode away from the cathode, reducing the amount of generated water accumulated in the cathode. Accordingly, it is possible to maintain appropriate humidity of the fuel cell stack 100.

On the other hand, if it is determined that the temperature increase at the anode outlet is greater than the temperature increase at the cathode outlet (S360), the controller 500 may determine that flooding has occurred at the anode and pressurize the anode (S430).

If it is determined that flooding occurs mainly at the anode, the controller 500 gradually pressurizes the anode by adjusting the opening degree of the hydrogen supply valve 310 to push the generated water generated in the anode away from the anode, thereby reducing the amount of generated water accumulated in the anode. Accordingly, it is possible to maintain appropriate humidity of the fuel cell stack 100.

In addition, if it is determined that the fuel cell stack 100 is in a drying state because the temperature difference between the coolant inlet and the coolant outlet is lower than the lower limit of the reference range, and in a case where it is determined that the temperature decrease at the cathode outlet is greater than the temperature decrease at the anode outlet (S350), the controller 500 may determine that the cathode is dry and pressurize the anode (S410).

If it is determined that drying has occurred at the cathode, the controller 500 gradually pressurizes the anode by adjusting the opening degree of the hydrogen supply valve 310 to push the generated water generated in the anode to the cathode, thereby reducing the amount of generated water accumulated in the anode and moving the generated water to the cathode. Accordingly, it is possible to maintain appropriate humidity of the fuel cell stack 100.

On the other hand, if it is determined that the temperature decrease at the anode outlet is greater than the temperature decrease at the cathode outlet (S352), the controller 500 may determine that the anode is dry and pressurize the cathode (S420).

If it is determined that drying has occurred at the anode, the controller 500 gradually pressurizes the cathode by driving the air compressor 210 to push the generated water generated in the cathode to the anode, thereby reducing the amount of generated water accumulated in the cathode and moving the generated water to the anode. Accordingly, it is possible to maintain appropriate humidity of the fuel cell stack 100.

Meanwhile, the controller 500 stores the output current section of the fuel cell stack 100 where a cell voltage deviation is measured to be less than the reference deviation, and when the current output current of the fuel cell stack 100 is included within the stored output current section of the fuel cell stack 100, the controller 500 may determine the state of one or more of the cathode and the anode based on the temperature change of one or more of the cathode outlet and the anode outlet (S350, S360).

Specifically, after the controller 500 changes the operating temperature of the fuel cell stack 100 (S310, S320), the controller 500 monitors one or more of the cathode outlet temperature and the anode outlet temperature (S330, S340).

However, the controller 500 identifies whether the current output current of the fuel cell stack 100 is included in the output current section of the fuel cell stack in which the cell voltage deviation is measured to be less than the reference deviation, and, after satisfying that the current output current of the fuel cell stack 100 is included in the output current section of the fuel cell stack in which the cell voltage deviation is measured to be less than the reference deviation, the controller 500 may determine the state of one or more of the cathode and the anode based on the temperature change of one or more of the cathode outlet and the anode outlet (S350, S360).

In other words, since it is to recover the cell performance deviation in the output current section where the cell voltage deviation decreases, the controller 500 performs the controlling (S400) to recover the cell performance deviation after it is satisfied that the current output current is included in the output current section of the fuel cell stack where the cell voltage deviation is measured to be less than the reference deviation (S400).

Thereafter, the controller 500 may pressurize one or more of the cathode and the anode according to the result of determining the state of one or more of the cathode and the anode (S400), and thereafter, the controller 500 may monitor whether the cell voltage deviation has recovered to more than the reference deviation within the stored output current section of the fuel cell stack.

Although embodiments of the disclosure have been illustrated and described in connection with the preferred embodiments, it will be readily understood by those skilled in the art that various modifications and changes can be made thereto without departing from the spirit and scope of the disclosure defined by the appended claims.

The following reference identifiers may be used in connection with the drawings in describing preferred embodiments of the present disclosure.
100: fuel cell stack
20: air supply system
210: air compressor
230: air flow control valve
250: air pressure control valve
30: hydrogen supply system
310: hydrogen supply valve
330: hydrogen purge valve
350: ejector
370: hydrogen tank
400: humidifier
500: controller

What is claimed is:

1. A fuel cell system, comprising:
a fuel cell stack comprising a cathode and an anode; and
a controller configured to:
determine a drying state or a flooding state of the fuel cell stack based on a temperature difference between a coolant inlet and a coolant outlet;
determine a state of the cathode or the anode or both based on a temperature change of a cathode outlet or an anode outlet or both; and
pressurize the cathode or the anode or both based on the state of the cathode or the anode.

2. The fuel cell system of claim 1, wherein, in a case in which a cell voltage deviation of the fuel cell stack is less than a reference deviation, the controller is configured to determine the drying state or the flooding state of the fuel cell stack based on the temperature difference between the coolant inlet and the coolant outlet.

3. The fuel cell system of claim 1, wherein the controller is configured to:
calculate a higher heating value and a lower heating value of the fuel cell stack based on an output voltage or an output current of the fuel cell stack or both;
set a reference range based on the higher heating value and the lower heating value; and
determine the drying state or the flooding state of the fuel cell stack by comparing the temperature difference between the coolant inlet and the coolant outlet and the reference range.

4. The fuel cell system of claim 3, wherein, in a case in which the temperature difference between the coolant inlet and the coolant outlet is outside the reference range, the controller is configured to determine that the fuel cell stack is currently in the drying state or the flooding state.

5. The fuel cell system of claim 1, wherein:
in a case in which the fuel cell stack is determined to be in the flooding state, the controller is configured to increase an operating temperature of the fuel cell stack; and
in a case in which the fuel cell stack is determined to be in the drying state, the controller is configured to reduce the operating temperature of the fuel cell stack.

6. The fuel cell system of claim 5, wherein, in the case in which the fuel cell stack is determined to be in the flooding state and in a case in which a temperature increase at the cathode outlet is determined to be greater than that at the anode outlet, the controller is configured to determine that flooding has occurred at the cathode and pressurize the cathode.

7. The fuel cell system of claim 5, wherein, in the case in which the fuel cell stack is determined to be in the flooding state and in a case in which a temperature increase at the anode outlet is determined to be greater than that at the cathode outlet, the controller is configured to determine that flooding has occurred at the anode and pressurize the anode.

8. The fuel cell system of claim 5, wherein, in the case in which the fuel cell stack is determined to be in the drying state and in a case in which a temperature decrease at the cathode outlet is determined to be greater than that at the anode outlet, the controller is configured to determine that the cathode is dry and pressurize the anode.

9. The fuel cell system of claim 5, wherein, in the case in which the fuel cell stack is determined to be in the drying state and in a case in which a temperature decrease at the anode outlet is determined to be greater than that at the cathode outlet, the controller is configured to determine that the anode is dry and pressurize the cathode.

10. The fuel cell system of claim 5, wherein:
the controller is configured to store an output current section of the fuel cell stack where a cell voltage deviation is measured to be less than a reference deviation; and
in a case in which a current output current of the fuel cell stack is included in the stored output current section of the fuel cell stack, the controller is configured to determine the state of the cathode or the anode or both based on the temperature change of the cathode outlet or the anode outlet or both.

11. The fuel cell system of claim 10, wherein the controller is configured to pressurize the cathode or the anode or both according to a result of determining the state of the cathode or the anode or both.

12. The fuel cell system of claim 11, wherein, after the cathode or the anode or both are pressurized, the controller is configured to monitor whether the cell voltage deviation is greater than or equal to the reference deviation within the stored output current section of the fuel cell stack.

13. A control method of a fuel cell system performed by a controller, the control method comprising:
determining a drying state or a flooding state of a fuel cell stack based on a temperature difference between a coolant inlet and a coolant outlet;
determining a state of a cathode or an anode or both based on a temperature change of a cathode outlet or an anode outlet or both; and
pressurizing the cathode or the anode or both based on the state of the cathode or the anode.

14. The control method of claim 13, wherein, in determining the drying state or the flooding state of the fuel cell stack, in a case in which a cell voltage deviation of the fuel cell stack is less than a reference deviation, the drying state or the flooding state of the fuel cell stack is determined based on the temperature difference between the coolant inlet and the coolant outlet.

15. The control method of claim 13, wherein determining the drying state or the flooding state of the fuel cell stack further comprises:
calculating a higher heating value and a lower heating value of the fuel cell stack based on an output voltage or an output current of the fuel cell stack or both;
setting a reference range based on the higher heating value and the lower heating value; and
determining the drying state or the flooding state of the fuel cell stack by comparing the temperature difference between the coolant inlet and the coolant outlet and the reference range.

16. The control method of claim 15, wherein, in a case in which the temperature difference between the coolant inlet and the coolant outlet is outside the reference range, the control method further comprises determining that the fuel cell stack is currently in the drying state or the flooding state.

17. The control method of claim 13, wherein:
in a case in which the fuel cell stack is determined to be in the flooding state, the control method further comprises increasing an operating temperature of the fuel cell stack; and
in a case in which the fuel cell stack is determined to be in the drying state, the control method further comprises reducing the operating temperature of the fuel cell stack.

18. The control method of claim 13, wherein:
in a first case in which the fuel cell stack is determined to be in the flooding state and a temperature increase at the cathode outlet is determined to be greater than a temperature increase at the anode outlet, the control method further comprises determining that flooding has occurred at the cathode and pressurizing the cathode;
in a second case in which the fuel cell stack is determined to be in the flooding state and the temperature increase at the anode outlet is determined to be greater than the temperature increase at the cathode outlet, the control method further comprises determining that flooding has occurred at the anode and pressurizing the anode;
in a third case in which the fuel cell stack is determined to be in the drying state and a temperature decrease at the cathode outlet is determined to be greater than a temperature decrease at the anode outlet, the control method further comprises determining that the cathode is dry and pressurizing the anode; and
in a fourth case in which the fuel cell stack is determined to be in the drying state and the temperature decrease at the anode outlet is determined to be greater than the temperature decrease at the cathode outlet, the control method further comprises determining that the anode is dry and pressurizing the cathode.

19. The control method of claim 13, further comprising:
storing an output current section of the fuel cell stack where a cell voltage deviation is measured to be less than a reference deviation; and
in a case in which a current output current of the fuel cell stack is included in the stored output current section of the fuel cell stack, determining the state of the cathode or the anode or both based on the temperature change of the cathode outlet or the anode outlet or both.

20. The control method of claim 19, further comprising:
pressurizing the cathode or the anode or both according to a result of determining the state of the cathode or the anode or both; and
after pressurizing the cathode or the anode or both, monitoring whether the cell voltage deviation is greater than or equal to the reference deviation within the stored output current section of the fuel cell stack.
